(19) United States
(12) Patent Application Publication
(10) Pub. No.: US 2022/0018587 A1
(43) Pub. Date: Jan. 20, 2022

(54) DRY ICE-BASED COOLING METHOD AND APPARATUS

(71) Applicant: Fernando JACOME BRANDAO, Belo Horizonte (BR)

(72) Inventor: Fernando JACOME BRANDAO, Belo Horizonte (BR)

(21) Appl. No.: 17/414,365

(22) PCT Filed: Jun. 17, 2019
(86) PCT No.: PCT/BR2019/050224

§ 371 Date: Jun. 16, 2021

(30) Foreign Application Priority Data
Jan. 7, 2019 (BR) BR 10 20190002280

(51) Int. Cl. F25D 3/10; F17C 7/04

(52) U.S. Cl. CPC F25D 3/10; F17C 2221/013; F17C 7/04

(57) ABSTRACT

The present invention, which falls within the field of refrigeration methods, is configured in a controlled system that uses the liquid fraction of dry ice as a heat exchanger. The method uses dry ice and pressures above 5.1atm so that the three phases coexist: solid, liquid and gaseous carbon dioxide. Through a connection in the container (1) the liquid fraction can be directed to another container (3) where the heat exchange occurs with the substance to be refrigerated, which causes the liquid CO2 to return to the gaseous state, which in turn can be directed to the container (5) for gas reuse. The system can have pressure switches, thermocouples, relays, pumps, valves and solenoids to control the conditions in each container and guarantee the integrity of the system.

The present invention, which falls within the field of refrigeration methods, is configured in a controlled system that uses dry ice and pressures above 5.1 atm so that the three phases coexist: solid, liquid and gaseous carbon dioxide. The liquid fraction produced by the system can be directed to another container so that heat exchange occurs with another substance.

Currently the cooling equipment present on the market and in the state of the art takes advantage of the phenomenon of sublimation of the substance, directing the cold gaseous part or using a secondary substance, such as a refrigerant gas or antifreeze liquid, to exchange heat with CO₂ solid by means of suitable coils or exchangers.

Another type of refrigeration commonly used is through forced air, which consists of a container with CO₂ solid and ventilation, in which the air passes in a cold internal path, made by dry ice and reaches the proposed container, the ventilation being interrupted when it reaches the ideal temperature.

Patent application PI 0416764-3 describes a CO₂ cooling system which includes an evaporator, suction lines and a two-stage compressor, this system, in addition to not using dry ice as a source of carbon dioxide, still needs an electric compressor to generate the necessary pressure.

The invention described in WO2007111675 discloses a refrigerator/container with a dry ice sublimation regulation system that has an insulated dry ice module so that the outer surface of the module is not dangerous to touch. As sublimated dry ice is carbon dioxide and heavier than normal air, it falls to the bottom of the coolest and accumulates, that is, the system uses only the gas fraction of carbon dioxide.

The utility model presented in MU 8301333-4 comprises the cooling of some liquid through the coil that can be cooled from the solid dry ice, the cold liquid that is inside the coil pipe will connect, connect to the exchanger, which in turn will freeze, and is then used for room cooling.

Aiming at the need to create an efficient cooling method that makes the most of the properties of CO₂, consumes little energy and can reuse the products created in each stage, the proposed system was elaborated according to:

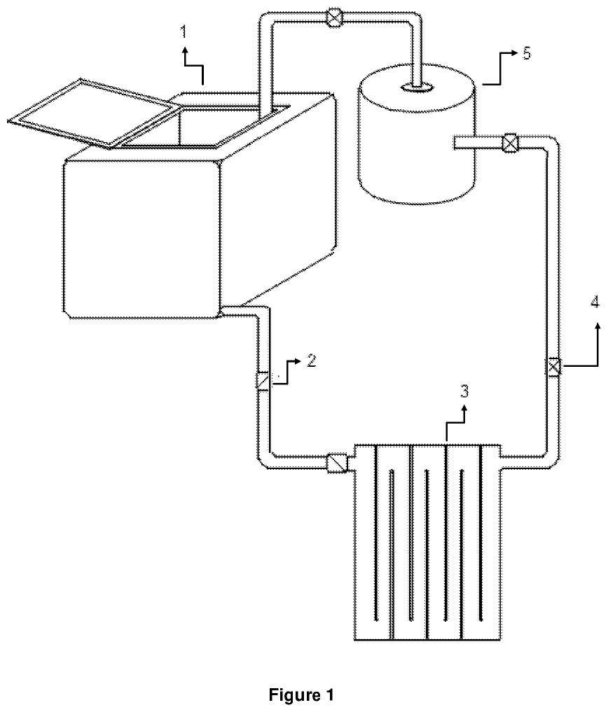

FIG. 1: General representation of the dry ice cooling method and apparatus, consisting of:
(1) Container dry ice that withstands pressures above 5.1 atm where the liquid phase of CO₂ can be removed by a fisherman or by the bottom of the container. With the container closed, the dry ice begins to sublimate and exert pressure, which is controlled by a safety valve, until the solid/liquid/vapor phases coexist, the liquid is then extracted at temperatures below −56° C. The pressure required to reach the triple point of carbon dioxide can also be achieved with the use of external CO2 sources or heat source, in order to accelerate the process.
(2) Valves, solenoids and thermostats to control the temperature and pressure of the container (3), by measuring the flow rate of the liquid coming from the container (1).
(3) Evaporator, which can have different shapes, such as tubular, plates, containers, direct contact exchangers, not limited to them. As well as, varied uses such as beer coolers, air conditioning, industrial refrigeration, freezers, refrigerators, breweries, heat exchangers and conservators, not limited to them.
(4) CO₂ flow controlled by solenoids, pressure switch and valves. In this stage, there is a differential adjustment pressure switch to maintain the integrity of the system and a flow regulator to adjust the evaporation speed and not remove all CO2 from the system.
(5) CO₂ storage container, where excess gas can be released into the atmosphere or reused for various purposes such as: storing the pressure for the system's initial activation itself, if the product needs CO2, the system's own CO2 can be used for flow, carbonation, mixer, some pneumatic action as well as being intended for a CO2 reuse system, again, not limited to them.
The CO2 Container (5) can be connected by the CO2 flow controlled by solenoids, pressure switch and valves (4) or by the Dry Ice Container (1).

The system also has the following advantages: quick and controllable cooling, the use of little electrical energy and low loss of solid CO2 to the external environment, being ideal for cooling machines in which there is no need to use compressors.

With all the stages of the system controlled by actuating the valves, the cooling apparatus does not present any risks during its operation and can be used from small residences to large events or industries.

1. COOLING METHOD AND APPARATUS characterized by a controlled cooling system, where the container (1) is under pressure and the three phases of carbon dioxide coexist: solid, liquid and gaseous, the liquid fraction present in (1) can be directed to another container (3) to perform the heat exchange with another substance, after the exchange occurs evaporation and the gaseous CO2 formed can be stored in (5) and reused for various purposes.

2. COOLING METHOD AND APPARATUS, according to claim 1, CHARACTERIZED for containing an evaporator (3) they can have different shapes, such as tubular, plates, containers, direct contact exchangers, not limited to them, as well as, also varied uses such as in beer coolers, air conditioning, industrial refrigeration, freezers, refrigerators, breweries, heat exchangers and conservators, not limited to them.

3. COOLING METHOD AND APPARATUS, according to claim 1, CHARACTERIZED for containing, if necessary, pressure switches, pumps, thermocouples, relays, valves and solenoids to control the temperature and pressure conditions in each container ensuring system integrity.

4. COOLING METHOD AND APPARATUS, according to claim 1, CHARACTERIZED for containing pressure relief valves for removing excess gas from the system, reusing it, if necessary, for opening and closing the solenoid with pneumatic activation, in cases of removal of carbonated drinks, CO₂ recycling plant, not limited to them.

5. COOLING METHOD AND APPARATUS, CHARACTERIZED by a method that uses substances with high energy absorption rates, especially dry ice, pressures above 5.1 atm for controlled cooling of other substances.
